(19) United States
(12) Patent Application Publication
(10) Pub. No.: US 2013/0156537 A1
(43) Pub. Date: Jun. 20, 2013

(54) CARRIER AND SUBSTRATE UNLOADING METHOD USING THE SAME

(71) Applicants: Po-Yuan Lo, Taipei City (TW); Ru-De Chen, Taichung City (TW)

(72) Inventors: Po-Yuan Lo, Taipei City (TW); Ru-De Chen, Taichung City (TW)

(73) Assignee: INDUSTRIAL TECHNOLOGY RESEARCH INSTITUTE, HSINCHU (TW)

(21) Appl. No.: 13/476,639

(22) Filed: May 21, 2012

(30) Foreign Application Priority Data
Dec. 19, 2011 (TW) 100147222

(51) Int. Cl. B65D 81/02; B65D 85/30; B65D 85/48; B65G 65/00

(52) U.S. Cl. 414/800; 206/449; 206/555; 206/454

(57) ABSTRACT

A carrier and a substrate unloading method using the same are provided. The carrier comprises a bottom board, a rim and a stop board. The bottom board is for carrying a substrate. The rim is disposed on a periphery of the bottom board. The rim has at least one opening. The stop board is disposed on the rim. One end of the stop board is pivotally connected to the rim, and the other end of the stop board is rotated to the outside or the inside of the rim.

This application claims the benefit of Taiwan application Serial No. 100147222, filed Dec. 19, 2011, the subject matter of which is incorporated herein by reference.

### BACKGROUND

1. Technical Field

The disclosure relates to a carrier of a substrate and a substrate unloading method using the same.

2. Description of the Related Art

Along with the advance in technology, various electronic products are continually provided, and particularly the portable products having the features of lightweight, slimness and compactness have gained dramatic growth. Let the display panels of portable products be taken for example. The substrate is directed towards thinness and lightweight. The thickness of a single substrate which normally ranged between 1.1 to 0.7 millimeter (mm) in early stages has now been reduced to 0.5 mm.

However, if the thickness of a substrate is smaller than 0.5 mm, the substrate, which becomes deflected and may be easily damaged, cannot be transported in the current production line for panels. For the current production line for panels, substrates are transported by way of roller transportation or robotic arm transportation. According to the roller transportation, a substrate laid horizontally is transported with the rollers underneath the substrate. The roller transportation is not applicable to the thin-type substrate which is too light to generate sufficient friction between the substrate and the rollers for transporting the substrate. According to the robotic arm transportation, a robotic arm is firstly attached to the bottom of a substrate by way of vacuum absorption for carrying and fixing the substrate, and then the substrate is transported by the robotic arm. However, if the substrate is too thin, the substrate may bend downward or even become deformed at the location of vacuum absorption. Therefore, how to adapt the thin-type substrate to the current production line has become an imminent task for the industries.

### SUMMARY

The disclosure is directed to a carrier and a substrate unloading method using the same. The carrier comprises a bottom board, a rim and a stop board. The bottom board is for carrying a substrate. The rim is disposed on a periphery of the bottom board. The rim has at least one opening. The stop board is disposed on the rim. One end of the stop board is pivotally connected to the rim, and the other end of the stop board is rotated to the outside or the inside of the rim.

According to another aspect of the disclosure, a substrate unloading method for a carrier is provided. The method comprises the following steps. A carrier is provided. The carrier comprises a bottom board, a rim and at least one stop board. The bottom board is for carrying a substrate. The bottom board has at least one through hole. The rim is disposed on a periphery of the bottom board. The rim has at least one opening. The stop board is disposed on the rim. One end of the stop board is pivotally connected to the rim. The other end of the stop board is rotated to the outside of the rim. The substrate is lifted by a high-pressure gas or a pole passing through the through hole. The substrate is taken out through the opening by a robotic arm.

The above and other aspects of the disclosure will become better understood with regard to the following detailed description of but non-limiting embodiment(s). The following description is made with reference to the accompanying drawings.

### BRIEF DESCRIPTION OF THE DRAWINGS

FIG. 1 shows a schematic diagram of a carrier according to a first embodiment;

FIG. 2 shows a schematic diagram of the carrier carrying a substrate according to the first embodiment;

FIG. 3 shows a cross-sectional view of the carrier of FIG. 2 along a cross-sectional line 3-3 according to the first embodiment;

FIG. 4 shows a cross-sectional view of the carrier of FIG. 2 along a cross-sectional line 4-4 according to the first embodiment;

FIG. 5 shows a cross-sectional view of the carrier of FIG. 2 along a cross-sectional line 5-5 according to the first embodiment;

FIG. 6 shows another schematic diagram of the carrier unloading the substrate according to the first embodiment;

FIG. 7 shows another schematic diagram of the carrier unloading the substrate according to the first embodiment;

FIG. 8 shows another schematic diagram of the carrier unloading the substrate according to the first embodiment;

FIG. 9 shows a schematic diagram of a carrier according to a second embodiment;

FIG. 10 shows a schematic diagram of a carrier according to a third embodiment;

FIG. 11 shows a schematic diagram of a carrier according to a fourth embodiment;

FIG. 12 shows a schematic diagram of a carrier according to a fifth embodiment.

### DETAILED DESCRIPTION

### First Embodiment

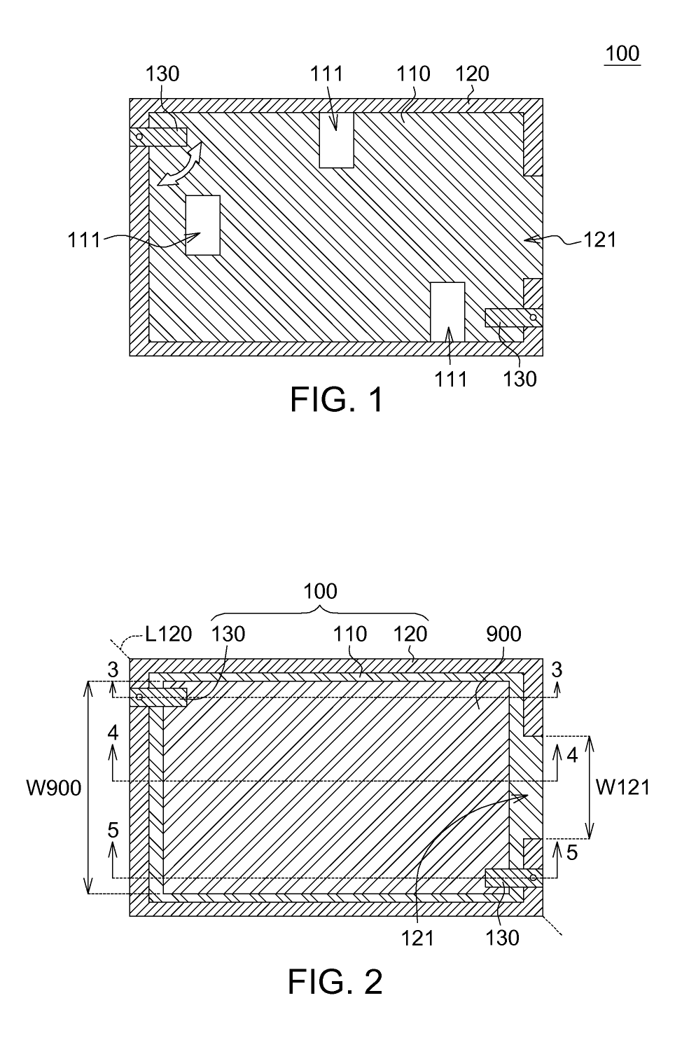

Referring to FIG. 1, a schematic diagram of a carrier 100 according to a first embodiment is shown. The carrier 100 comprises a bottom board 110, a rim 120 and two stop boards 130. The bottom board 110 has three through holes 111 whose total area is smaller than a half of the area of the bottom board 110. The through holes 111 expedite the draining of the process liquid. The number of the through holes 111 is associated with the area of the bottom board 110. The bottom board 110 can have one, two or more than two through holes 111. If the bottom board 110 has only one through hole 111, the single through hole 111 is big for conveniently draining impurities with big particles. If the bottom board 110 has more through holes 111, the bottom board 110 and the substrate 900 are supported in a uniform manner to maintain a robust supporting structure. The rim 120 is disposed on a periphery of the bottom board 110. The material of the rim 120 is such as glass, Teflon, plastic or metal. The stop board 130 is disposed on the rim 120. The material of the stop board 130 is such as glass, Teflon, plastic or metal. One end of the stop board 130 is pivotally connected to the rim 120.

The rim 120 has an opening 121. After the carrier 100 carrying a substrate to be performed a wet process (such as a cleaning process or a wet etching process), the opening 121 expedites the draining of the process liquid. In the wet etching process, the length of duration is a critical parameter. The more quickly the process liquid is drained, the more precisely the soaking time can be controlled. Particularly, as the manufacturing process for panel, semiconductor wafer or micro-electromechanical system is directed towards the tendency of miniaturization and precision, the soaking time of the wet etching process needs to be precisely controlled to avoid the occurrence of over-etching or under-etching.

FIG. 2 shows a schematic diagram of a carrier 100 carrying a substrate 900 according to the first embodiment. The carrier 100 can be used in the manufacturing process of a thin-type display or a 3D integrated circuit for transporting the substrate 900 from one operating station to another operating station. In some operating stations, the substrate 90 is treated in conjunction with the carrier 100.

In the present embodiment of the disclosure, the rim 120 has only one single opening 121 located at the center of an edge of the rim 120. Anyone who is skilled in the technology of the disclosure can adjust the quantity and the location of the opening 121 to fit actual needs, and the quantity and the location of the opening 121 are not limited to the above exemplification. The width W121 of the opening 121 is smaller than the width W900 of the substrate 900, so that the substrate 900 will not slide off the opening 121. When the substrate 900 is disposed on the bottom board 110, the rim 120 surrounds the substrate 900 to avoid the substrate 900 coming off the bottom board 110. In the present embodiment of the disclosure, the height D120 of the rim 120 is larger than the thickness D900 of the substrate 900 to effectively avoid the substrate 900 coming off the bottom board 110. In an embodiment, taking the material of the substrate 900 and the liquidity of process liquid into consideration, the height D120 of the rim 120 can be smaller than or equal to the thickness D900 of the substrate 900.

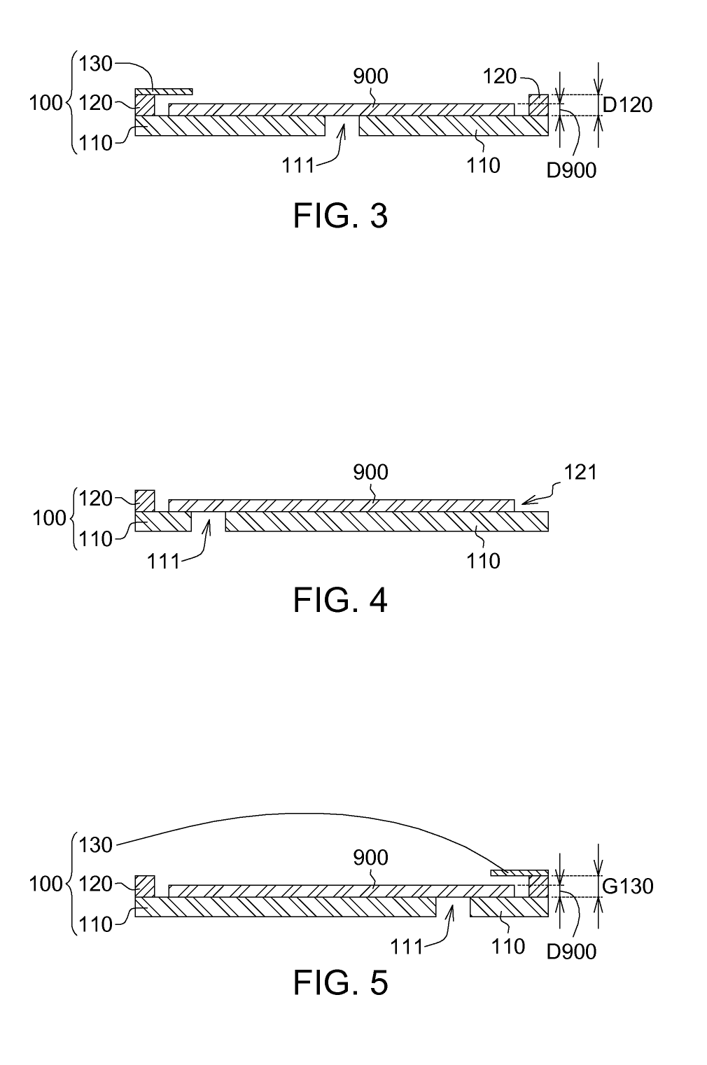

Please refer to FIGS. 3 to 5. FIG. 3 shows a cross-sectional view of the carrier 100 of FIG. 2 along a cross-sectional line 3-3 according to the first embodiment. FIG. 4 shows a cross-sectional view of the carrier 100 of FIG. 2 along a cross-sectional line 4-4 according to the first embodiment. FIG. 5 shows a cross-sectional view of the carrier 100 of FIG. 2 along a cross-sectional line 5-5 according to the first embodiment.

As indicated in FIG. 3 and FIG. 4, when another end of the stop board 130 is rotated to the inside of the rim 120, the stop board 130 and the bottom board 110 are respectively located on the top and the bottom of the periphery of the substrate 900. Thus, the stop board 130 avoids the substrate 900 coming off the carrier 100 in the course of transportation.

The number of stop boards 130 is non-limiting. In the present embodiment of the disclosure, the carrier 100 has two stop boards 130. Since the rim 120 is a rectangle, the stop boards 130 are located on a diagonal line L120 of the rim 120. Thus, the substrate 900 will not easily come off from any edge of the rim 120.

In the present embodiment of the disclosure, the distance G130 between the stop board 130 and the bottom board 110 is larger than the thickness D900 of the substrate 900. Thus, the stop board 130 will not press the substrate 900 too tightly, such that the substrate 900 is prevented from any damage of breaking. Furthermore, the substrate 900 does not contact with the bottom board 110 too tightly, so that the process liquid can be drained from the through holes 111 of the bottom board 110 easily.

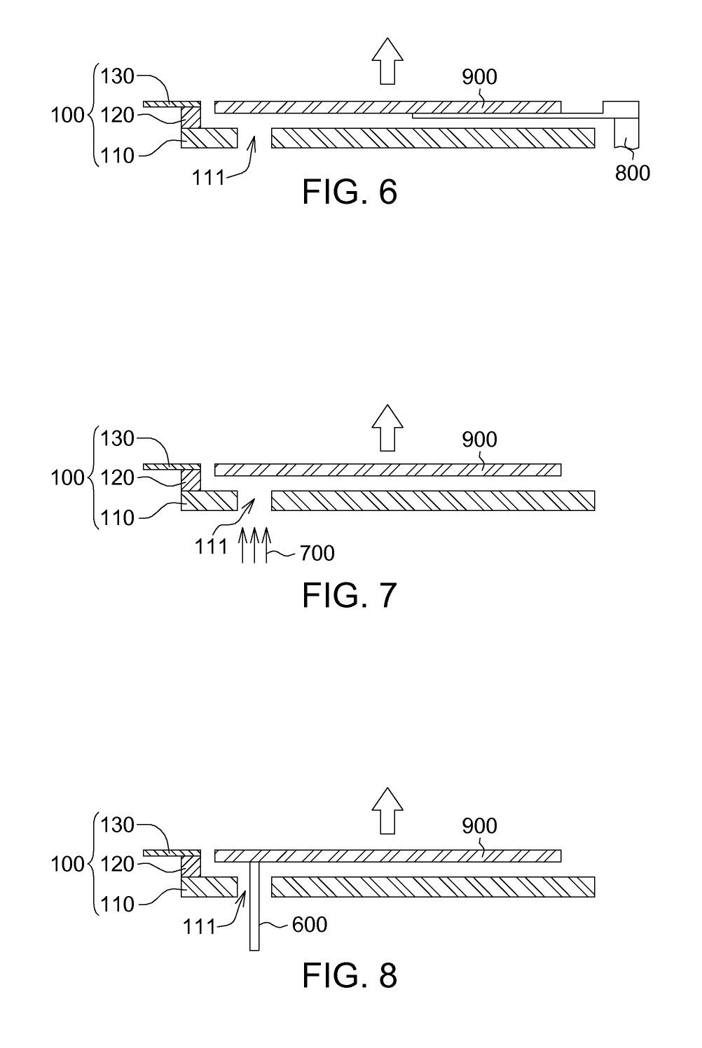

Referring to FIG. 6, another schematic diagram of the carrier 100 unloading the substrate 900 according to the first embodiment is shown. When the substrate 900 is to be unloaded from the carrier 100, the stop board 130 is rotated to the outside of the rim 120 first, and then the substrate 900 is taken out through the opening 121 by a robotic arm 800.

Alternatively, as indicated in FIG. 7, another schematic diagram of the carrier 100 unloading the substrate 900 according to the first embodiment is shown. When the substrate 900 is to be unloaded from the carrier 100, the stop board 130 is rotated to the outside of the rim 120 first, and then the substrate 900 lifted by a high-pressure gas 700 applied through the through hole 111 can be taken out accordingly.

Alternatively, as indicated in FIG. 8, another schematic diagram of the carrier 100 unloading the substrate 900 according to the first embodiment is sown. When the substrate 900 is to be unloaded from the carrier 100, the stop board 130 is rotated to the outside of the rim 120 first, and then the substrate 900 is lifted by a pole 600 passing through the through hole 111 to be taken out accordingly.

In compliance with the thinning tendency, the thickness D900 of the substrate 900 is normally smaller than 1 mm or even is smaller than 0.2 mm. The material of the substrate 900 is such as glass, metal, plastic or silicon. In the course of transporting the substrate 900, the substrate 900 may be deformed and the quality is thus affected. In a film process which requires higher level of precision, various process factors need to be controlled carefully. With the design of the bottom board 110, the rim 120 and the stop board 130 will not be deformed easily in the course of transportation, the substrate 900 can be remained flat without being bended or deformed, and the process liquid can be quickly drained, such that the process can be controlled with high precision.

### Second Embodiment

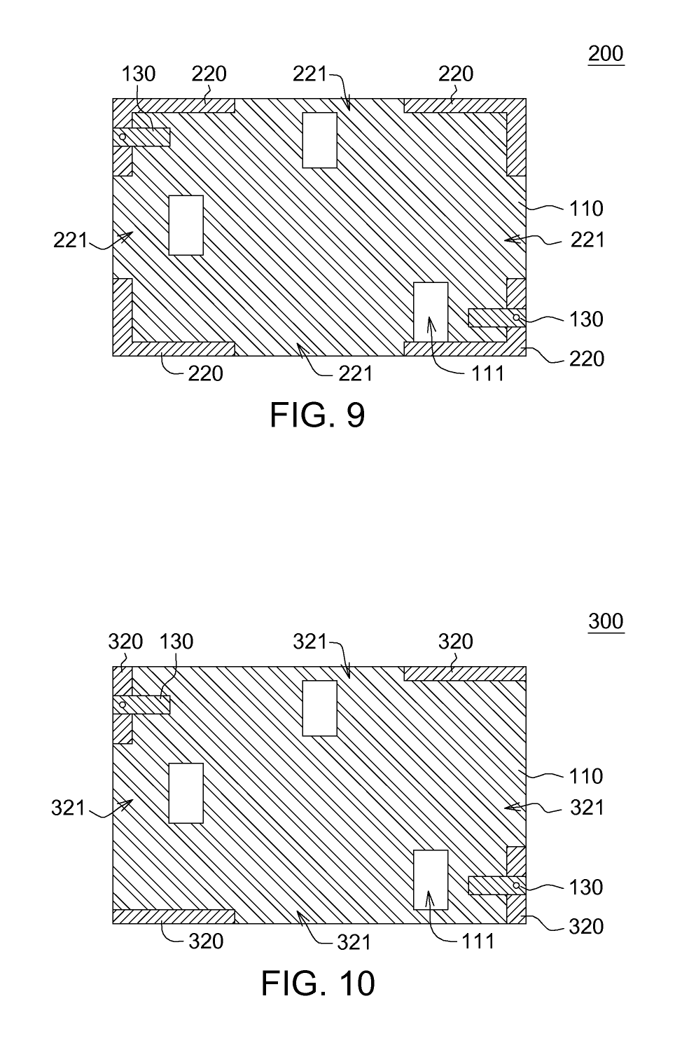

Referring to FIG. 9, a schematic diagram of a carrier 200 according to a second embodiment is shown. The carrier 200 of the present embodiment of the disclosure is different from the carrier 100 of the first embodiment in the design of the rim 220, and the similarities are not repeated here.

In the present embodiment of the disclosure, the rim has four openings 221 each being located at the center of an edge of the rim 220. If the substrate 900 (illustrated in FIG. 2) has a large area, or the wet etching process requires a high precision level of time control and the rim 220 has sufficient stability, then the number of the openings 221 can be increased to expedite the draining of the process liquid.

### Third Embodiment

Referring to FIG. 10, a schematic diagram of a carrier 300 according to a third embodiment is shown. The carrier 300 of the present embodiment of the disclosure is different from the carrier 100 of the first embodiment in the design of the rim 320, and the similarities are not repeated here.

In the present embodiment of the disclosure, the rim 320 has four openings 321 each being located on an edge of the rim 320. Each opening 321 does not have to be at the center of an edge. For example, each opening 321 can be near a corner of the rim 320. The locations of the openings 321 can be adjusted according to the structural strength of the carrier 300 and the shape and location of the substrate 900 (illustrated in FIG. 2).

### Fourth Embodiment

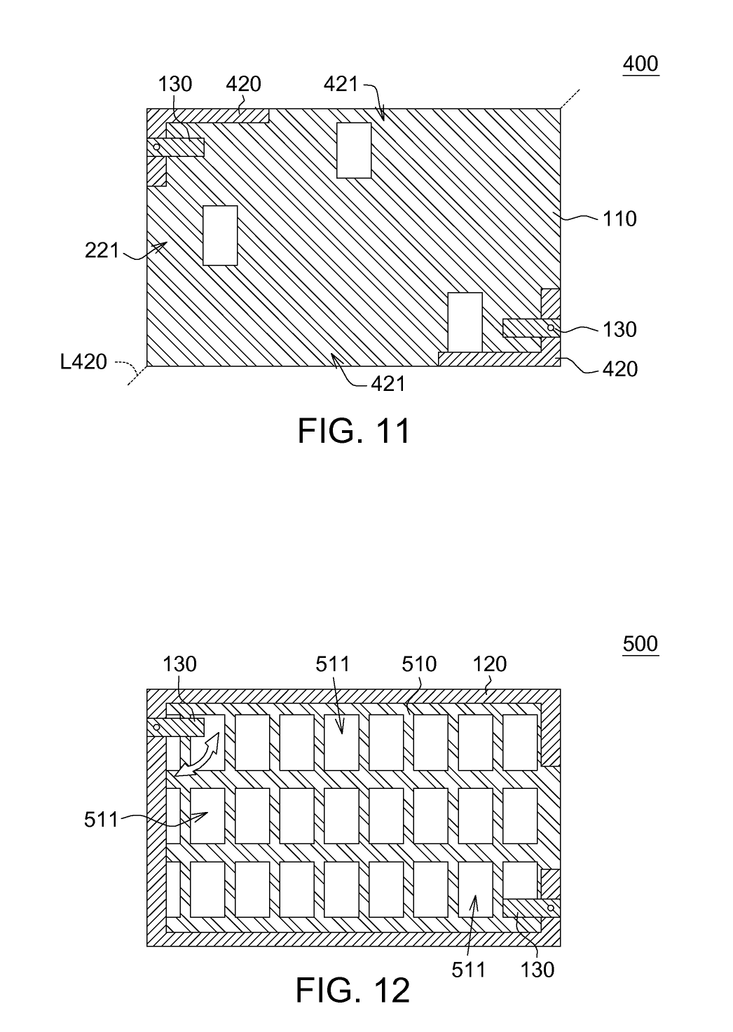

Referring to FIG. 11, a schematic diagram of a carrier 400 according to a fourth embodiment is shown. The carrier 400 of the present embodiment of the disclosure is different from the carrier 100 of the first embodiment in the design of the rim 420, and the similarities are not repeated here.

In the present embodiment of the disclosure, the rim 420 has two openings 421 respectively located at two corners of the rim 420. The two openings 421 correspond to a diagonal line L420 of the rim 420. Each opening 421 does not have to be located at the center of an edge. For example, each opening 421 can be near a corner of the rim. The locations of the openings 421 can be adjusted according to the structural strength of the carrier 400 and the shape and location of the substrate 900 (illustrated in FIG. 2).

### Fifth Embodiment

Referring to FIG. 12, a schematic diagram of a carrier 500 according to a fifth embodiment is shown. The carrier 500 of the present embodiment of the disclosure is different from the carrier 100 of the first embodiment in the design of through holes 511, and the similarities are not repeated here.

In the present embodiment of the disclosure, the through holes 511 are distributed in the form of a matrix, so that the bottom board 510 forms a reticular structure. The total area of the through holes 511 is larger than a half of the area of the bottom board 510. The through holes 511 can expedite the draining of the process liquid quickly.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A carrier, comprising:
a bottom board used for carrying a substrate;
a rim disposed on a periphery of the bottom board, wherein the rim has at least one opening; and
at least one stop board disposed on the rim, wherein one end of the stop board is pivotally connected to the rim, and the other end of the stop board is rotated to the outside or the inside of the rim.

2. The carrier according to claim 1, wherein the rim is a rectangle and has four openings each being located at an edge of the rim.

3. The carrier according to claim 1, wherein the rim is a rectangle and has two openings located at two corresponding corners of the rim.

4. The carrier according to claim 1, wherein the height of the rim is larger than the thickness of the substrate.

5. The carrier according to claim 1, wherein the bottom board has at least one through hole whose total area is smaller than a half of the area of the bottom board.

6. The carrier according to claim 1, wherein the bottom board has at least one through hole whose total area is larger than a half of the area of the bottom board.

7. The carrier according to claim 1, wherein the bottom board further comprises two or more than two through holes.

8. The carrier according to claim 1, wherein the number of the at least one stop board is two or more than two.

9. The carrier according to claim 8, wherein the rim is a rectangle, and two of the two or more than two stop boards are located on a diagonal line of the rim.

10. The carrier according to claim 1, wherein the distance between the stop board and the bottom board is larger than the thickness of the substrate.

11. The carrier according to claim 1, wherein the thickness of the substrate is smaller than 0.2 mm.

12. The carrier according to claim 1, wherein the material of the substrate is glass, metal, plastic or silicon.

13. A substrate unloading method for a carrier, wherein the method comprises:
providing a carrier which comprises a bottom board, a rim and at least one stop board, wherein the bottom board is for carrying a substrate, the bottom board has at least one through hole, the rim is disposed on a periphery of the bottom board, the rim has at least one opening, the stop board is disposed on the rim, and one end of the stop board is pivotally connected to the rim;
rotating the other end of the stop board to the outside of the rim;
lifting the substrate by a high-pressure gas or a pole passing through the through hole; and
taking out the substrate through the opening by a robotic arm.
